(19) United States
(12) Patent Application Publication
(10) Pub. No.: US 2003/0161094 A1
(43) Pub. Date: Aug. 28, 2003

(54) Folding/detachable computer screens

(76) Inventor: Donald Chambers, Savoy, IL (US)

Correspondence Address: Michael Berns, Maloney Parkinson & Berns, 135 West Main Street, Urbana, IL, 61801, US

(21) Appl. No.: 10/083,921

(22) Filed: Feb. 28, 2002

(51) Int. Cl. G06F 1/16

(52) U.S. Cl. 361/681

(57) ABSTRACT

This invention relates to a flat computer screen of the type which is in common use on laptop and hand-held computers where light weight and small size are of high importance to the computer user.

Flat-panel displays are well known pieces of hardware for viewing computer data. Laptop computers use a single display which is hinged at the backside, allowing the screen to be folded down on to the rest of the computer to take up a minimum of space while being transported.

Laptop displays, however, limit the number of open menus (windows) due to their relatively small size.

### BACKGROUND OF THE INVENTION

This invention relates to a flat computer screen of the type which is in common use on laptop and hand-held computers where light weight and small size are of high importance to the computer user.

Flat-panel displays are well known pieces of hardware for viewing computer data. Laptop computers use a single display which is hinged at the backside, allowing the screen to be folded down on to the rest of the computer to take up a minimum of space while being transported.

Laptop displays, however, limit the number of open menus (windows) due to their relatively small size.

### DECRIPTION OF THE PRIOR ART

Such displays are well known, but suffer from the disadvantage that, when the user is working in an application which requires multiple menus to be open at the same time or a large portion of the screen needs to be used for viewing an image little or no space is left for a working area.

### SUMMARY OF THE INVENTION

An object of this invention is to provide additional screen space for portable computing devices.

The prices of LCD (liquid crystal) displays are rapidly falling and their use along with even cheaper, flexible screens will continue to rise for use on computer and television displays. It is now possible to imprint micro-electronic structures on a variety of odd shaped and flexible surfaces, much like the screen printing process used for shirts or coffee cups. This is achieved by the layering of the three materials that make up transistors over a base surface and then using soft lithography of the electronic circuits. With this technology, screens can become extremely thin and lightweight and inexpensive. With the use of folding, detachable, or interlocking screens, their use and function can become greatly increased. If a laptop or other portable computing device had built-in provisions for folding or detachable ‘wings’ (displays that swing, plug in to, or pull out from the main screen) this limitation would be gone. The cursor would flow between the multiple screens, menus could all be kept on one screen while the other was left completely open for images or spreadsheets, you could be watching a DVD on one screen while surfing the internet on another etc.

Accordingly, this invention provides a hinged or plug-in connection to the main viewing screen and one or more viewing displays which can be folded in or out, plugged into, or slide out from the main screen.

### BRIEF DESCRIPTION OF THE DRAWINGS

FIG. 1 shows the computer in perspective with the display(s) unfolded/attached.

FIG. 2 illustrates the top view of the computer with the additional displays unfolded (or attached).

FIG. 3 shows the front view of the computer with the additional displays unfolded (or attached).

FIG. 4 shows the computer displays from the top, illustrating how they would swing if attached by hinges or a swiveling quick-connect mount.

FIG. 5 illustrates how the additional screens could slide out from inside the lid containing the main screen

### DETAILED DESCRIPTION OF THE DRAWINGS

According to the present invention additional screens could plug in to, swing out from, or slide out from the central (main) laptop display. This would allow significant additional space for multiple menus to be open simultaneously while maintaining the transport capabilities of the computer.

### EXAMPLE

A specific embodiment of the invention will now be described by way of example with reference to the accompanying drawing in which:

Referring to the drawing the computer comprises one or more screens (2,3) in addition to the main (central) display (1).

In order to utilize the additional displays (2,3) the screens will be unfolded from the central display (1) with hinges or swiveling quick-connect mounts (4,5) as shown in FIG. 4. They could also slide out from the central display (1) as shown in FIG. 5. FIG. 2 illustrates the additional screen space available for the user from the top. FIG. 3 shows the additional screen space available from a front view.

To return the laptop to small size for transportation or storage the steps described above are carried out in the reverse sequence.

1) A laptop or hand-held computer comprising additional display(s) which are swung out from the main display by utilizing hinges or quick attach connections to provide additional screen space for viewing extra windows or menus.

2) A laptop or hand-held computer as claimed in claim 1 wherein additional displays are swung out from the main display by means of one or multiple hinges.

3) A laptop or hand-held computer as claimed in claim 1 wherein additional displays are plugged into the sides of the main display by means of quick attach connections.

4) A laptop or hand-held computer as claimed in claim 1 wherein additional displays slide out from the main display.

5) A laptop or hand-held computer as claimed in any preceding claim, wherein additional thin displays are connected to the computer for extra viewing space.

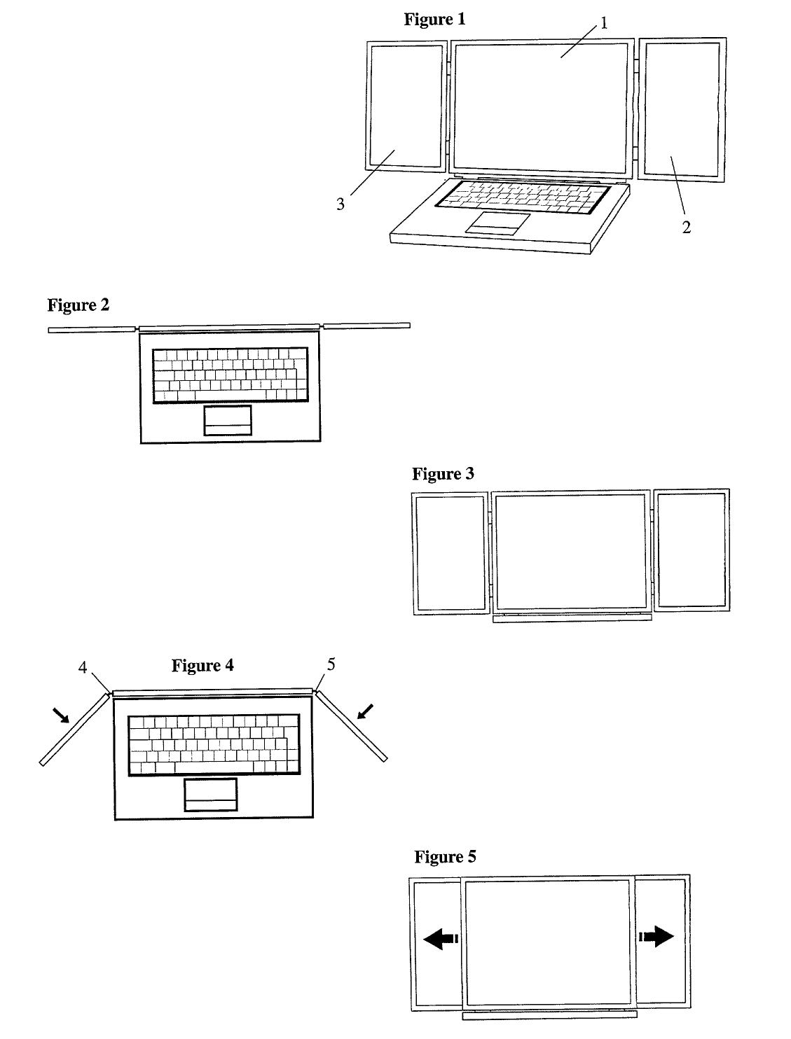

6) A laptop or hand-held computer with additional screens substantially as described herein with reference to FIGS. 1-5 of the accompanying drawing.
